(19) United States
(12) Patent Application Publication
(10) Pub. No.: US 2012/0099606 A1
(43) Pub. Date: Apr. 26, 2012

(54) TRANSMISSION APPARATUS, TRANSMISSION METHOD, AND COMMUNICATION SYSTEM

(75) Inventor: Katsuyuki Sato, TOKYO (JP)

(73) Assignee: SONY CORPORATION, Tokyo (JP)

(21) Appl. No.: 13/273,899

(22) Filed: Oct. 14, 2011

(30) Foreign Application Priority Data
Oct. 25, 2010 (JP) P2010-238171

(51) Int. Cl. H04J 3/16

(52) U.S. Cl. 370/468

(57) ABSTRACT

A transmission apparatus including: a communication unit that performs communication with a receiving apparatus; a transmission processing unit that transmits transmission data to the receiving apparatus via the communication unit; and a reproduction quality adjustment unit that adjusts a reproduction quality of the transmission data based on a retransmission request frequency that indicates a number of times that a retransmission request with respect to the transmission data is received from the receiving apparatus via the communication unit over a predetermined period of time.

### BACKGROUND

The present disclosure relates to a transmission apparatus, a transmission method, and a communication system.

In recent years, a communication system that transceiver audio data of music, sounds, or the like or image data of images (moving images or still images) between apparatuses by wired communication or wireless communication has been becoming widespread.

In such a context, techniques relating to a communication system that performs transceiving of data such that the transfer rate of the communication is not exceeded have been developed. As a technique of the transmission apparatus that transmits data in setting the bandwidth of a communication channel based on at least one of the content of the data that is transmitted, the type of apparatus that is the transmission destination, and the availability of wireless resources, the technique disclosed in Japanese Unexamined Patent Application Publication No. 2001-359200 is exemplified.

### SUMMARY

A technique of the related art relating to a communication system that performs transceiving of data such that the transfer rate of the communication is not exceeded (hereinafter, also referred to as “technique of the related art) sets the bandwidth of a communication channel based on at least one of the content of the data that is transmitted, the type of apparatus that is the transmission destination, and the availability of wireless resources. Therefore, a transmission apparatus that uses the technique of the related art (hereinafter also referred to as “transmission apparatus of the related art”) has the possibility of being able to transmit data to be transmitted (hereinafter, referred to as “transmission data”) to a receiving apparatus that is one transmission destination of the transmission data.

However, a communication system in which transceiving of data is performed by communication is not limited to a system in which a transmission apparatus transmits transmission data to one receiving apparatus. For example, as a communication system, a system that respectively transmits transmission data that corresponds to each receiving apparatus all at once to a plurality of receiving apparatuses that are transmission destinations of the transmission data is supposed. By the transmission apparatus transmitting transmission data to a plurality of receiving apparatuses that are transmission destinations all at once as above, a communication system in which reproducing the same content such as, for example, the same audio (including music, the same applies hereinafter) and images (moving images or still images. The same applies hereinafter) in each of the plurality of receiving apparatuses is possible is realized. Below, transmission data is described as data of content such as audio or images.

Here, with the technique of the related art, there is no consideration for a communication system in which a transmission apparatus transmits transmission data to a plurality of receiving apparatuses all at once as described above. Therefore, in a case when the technique of the related art is applied to the above communication system, for example, the transfer rate that indicates the data transfer amount for transmitting the transmission data that is transmitted from the transmission apparatus (hereinafter, referred to as “transmission transfer rate”) may exceed the transfer rate that indicates the data transfer amount of data that is able to be transmitted in the communication (hereinafter, referred to as “standard transfer rate”). In a case when the transmission transfer rate exceeds the standard transfer rate as above, there is a concern that an undesirable state of affairs such as, for example, the audio or images that are reproduced by the receiving apparatus breaking up occurs.

As a method for preventing the occurrence of an undesirable state of affairs as described above in a communication system in which a transmission apparatus transmits transmission data to a plurality of receiving apparatuses all at once, for example, the methods (a) to (d) below are supposed.

(a) The transmission apparatus limits the number of receiving apparatuses that are transmission destinations

(b) The transmission apparatus unifies the transmission data that is transmitted to each receiving apparatus as compressed audio data (generally, the audio quality (one example of reproduction quality) is lower than with uncompressed audio data) (in a case when the transmission data is audio data)

(c) The transmission apparatus unifies the transmission data that is transmitted to each receiving apparatus as image data with lower image quality (one example of reproduction quality) such as one or both of image data with a low resolution and image data of a compression format in which the compression rate is higher (in a case when the transmission data is image data of a moving image)

(d) The transmission apparatus unifies the transmission data that is transmitted to each receiving apparatus as image data with lower image quality (one example of reproduction quality) such as image data with a smaller data size (in a case when the transmission data is image data of a still image)

By adopting the methods shown in one or any of (a) and (b) to (d) above, for example, it is possible to increase (that is, to provide spare capacity to the bandwidth) the difference in the standard transfer rate and the transmission transfer rate (hereinafter, referred to as a “differential transfer rate”). Therefore, by applying the above methods, for example, in a communication system in which transmission data is transmitted all at once as described above, it is possible to prevent the occurrence of an undesirable state of affairs that arises due to the transmission transfer rate exceeding the standard transfer rate. Further, in the communication system in which the methods described above are applied, even in a case when the standard transfer rate is lowered due to the lowering of throughput in the communication, for example, it is possible to prevent the occurrence of an undesirable state of affairs as described above.

However, in a case when the occurrence of such an undesirable state of affairs is to be prevented by adopting the method of (a), the number of receiving apparatuses that are transmission destinations is limited considerably. Therefore, in a case when adopting the method of (a), there is a concern that convenience to the user that uses the communication system is lost.

Further, in a case when the occurrence of an undesirable state of affairs is to be prevented by adopting a method of (b) to (d) described above, even if there is spare capacity in the bandwidth in reality, transmission data with a lower reproduction quality such as transmission data with lower audio quality, for example, is transmitted to all receiving apparatuses that are transmission destinations. Therefore, in a case when adopting a method of (b) to (d), it is difficult to transmit transmission data with a higher reproduction quality to a receiving apparatus by the transmission apparatus making maximum use of the communication channel capacity.

Furthermore, the number of receiving apparatuses that are transmission destinations is inversely proportional to the securing of reproduction quality in the reproduction of transmission data by the receiving apparatuses within the entire communication system. Therefore, in a case when the method of (a) and the methods of (b) to (d) are combined, if the number of receiving apparatuses that are the transmission destinations is lowered, it is difficult to transmit transmission data with a high reproduction quality to the receiving apparatuses. Further, in a case when the method of (a) and the methods of (b) to (d) are combined, if transmission data with a high reproduction quality is transmitted to a receiving apparatus, since the limitation on the number of receiving apparatuses that are the transmission destinations is more severe, the possibility of the decreased convenience to the user increases.

Therefore, even by using the methods of (a) to (d), in a communication system in which transmission data is transmitted to a plurality of receiving apparatuses all at once, it is difficult to realize the securing of the reproduction quality in the reproduction of the transmission data by the receiving apparatuses while preventing a decrease in convenience to the user.

Therefore, a method of appropriately determining the reproduction quality of the transmission data that is transmitted from the transmission apparatus at the start of transmission is also supposed. In such a method, the reproduction quality of the transmission data is determined at the start of transmission by the infrastructure that is used for the transmission of the transmission data, the number of receiving apparatuses that are connected to the transmission apparatus, the transmission capacity of the transmission apparatus, and the like. As the type of infrastructure that is used for the transmission of the transmission data, types such as wired or wireless, a type such as a wireless method, or the like is supposed.

However, in a case when using wireless as the infrastructure, the electric field strength changes according to the distance between the transmission apparatus or the receiving apparatus and an access point, the presence of obstacles, the structure of a home, or the like, and the transfer rate of the transmission data from the transmission apparatus to the receiving apparatus is greatly influenced by such changes in the electric field strength. If the transfer rate changes, there may be spare capacity in the bandwidth or spare capacity may disappear from the bandwidth during communication.

On the other hand, in a situation in which communication is actually being performed between the transmission apparatus and a receiving apparatus, in a case when there is spare capacity in the bandwidth, or also in a case when there is no spare capacity in the bandwidth, it is the norm to continue to transmit transmission data to each receiving apparatus with the same reproduction quality as that determined at the start of the transmission of the transmission data. Therefore, with a method of appropriately determining the reproduction quality of the transmission data that is transmitted from the transmission apparatus at the start of transmission, there was a problem that a disparity occurs between the bandwidth and the reproduction quality in the communication.

It is desirable to provide a novel and improved transmission apparatus, a transmission method, and a communication system in which the disparity between the reproduction quality and the bandwidth of transmission data is reduced and in which adjustment of the reproduction quality according to the bandwidth is possible.

According to an embodiment of the disclosure, there is provided a transmission apparatus including: a communication unit that performs communication with a receiving apparatus; a transmission processing unit that transmits transmission data to the receiving apparatus via the communication unit; and a reproduction quality adjustment unit that adjusts the reproduction quality of the transmission data based on a retransmission request frequency that indicates the number of times that a retransmission request with respect to the transmission data is received from the receiving apparatus via the communication unit over a predetermined period of time.

The reproduction quality adjustment unit may adjust the reproduction quality of the transmission data based on the relationship between the retransmission request frequency and a predetermined frequency.

The transmission processing unit may transmit the transmission data of a first reproduction quality that is a predetermined reproduction quality or of a second reproduction quality which is lower than the first reproduction quality to the receiving apparatus, and the reproduction quality adjustment unit may change the reproduction quality of the transmission data to the second reproduction quality in a case when the reproduction quality of the transmission data that is currently being transmitted is the first reproduction quality and in a case when the retransmission request frequency is equal to or greater than a first predetermined frequency, and may change the reproduction quality of the transmission data to the first reproduction quality in a case when the reproduction quality of the transmission data that is currently being transmitted is the second reproduction quality and in a case when the retransmission request frequency is less than the second predetermined frequency.

The reproduction quality adjustment unit may not change the reproduction quality of the transmission data in a case when the reproduction quality of the transmission data that is currently being transmitted is the first reproduction quality and in a case when the retransmission request frequency is less than the first predetermined frequency, and may not change the reproduction quality of the transmission data in a case when the reproduction quality of the transmission data that is currently being transmitted is the second reproduction quality and in a case when the retransmission request frequency is equal to or greater than the second predetermined frequency.

The transmission apparatus may further include a reproduction quality setting unit that sets, in a case when there is a plurality of receiving apparatuses, the reproduction quality of the transmission data at the start of transmission for each of the receiving apparatuses based on the number of the plurality of receiving apparatuses, and the transmission processing unit may respectively transmit, at the start of transmission of the transmission data, the respective transmission data in which the reproduction quality is set for each of the receiving apparatuses by the reproduction quality setting unit to the corresponding receiving apparatuses.

The reproduction quality setting unit may set the reproduction quality of the transmission data at the start of transmission for each of the receiving apparatuses based on the relationship between the number of the plurality of receiving apparatuses and a predetermined number.

The reproduction quality setting unit may set the reproduction quality of the transmission data at the start of transmission to the first reproduction quality for each of the plurality of receiving apparatuses in a case when the number of the plurality of receiving apparatuses is less than the first predetermined number, and may set the reproduction quality of the transmission data at the start of transmission to the second reproduction quality for each of the plurality of receiving apparatuses in a case when the number of the plurality of receiving apparatuses is equal to or greater than the first predetermined number.

The reproduction quality setting unit may set the reproduction quality of the transmission data at the start of transmission to the second reproduction quality for each of the plurality of receiving apparatuses in a case when the number of the plurality of receiving apparatuses is equal to or greater than the first predetermined number and in a case when the number of the plurality of receiving apparatuses is less than a second predetermined number which is greater than the first predetermined number, and in a case when the number of the plurality of receiving apparatuses is equal to or greater than the second predetermined number, may select one fewer receiving apparatus than the second predetermined number of the plurality of receiving apparatuses and may set the reproduction quality of the transmission data at the start of transmission to the second reproduction quality for each of the selected receiving apparatuses that are one fewer than the second predetermined number.

The reproduction quality setting unit may omit setting of the reproduction quality of the transmission data at the start of transmission for each of one or a plurality of receiving apparatuses that have not been selected, and the transmission processing unit may not transmit the transmission data to any of one or a plurality of receiving apparatuses that have not been selected by the reproduction quality setting unit out of the plurality of receiving apparatuses.

The first predetermined frequency may be a higher value than the second predetermined frequency.

In a case when the transmission data is audio data of sounds, the transmission data of the first reproduction quality may be uncompressed audio data and the transmission data of the second reproduction quality may be audio data that is compressed in a predetermined compression format.

According to an embodiment of the disclosure, it is possible to reduce the disparity between the reproduction quality and the bandwidth of transmission data and to adjust the reproduction quality according to the bandwidth.

### BRIEF DESCRIPTION OF THE DRAWINGS

FIG. 1 is an explanatory diagram that illustrates the outline of a communication system according to the embodiment of the disclosure;

FIG. 2 is an explanatory diagram that illustrates one example of a process relating to a data transmission approach in a communication system according to the embodiment of the disclosure;

FIG. 3 is an explanatory diagram that illustrates one example of a format of the various types of requests that a transmission apparatus according to the embodiment of the disclosure transmits;

FIG. 4 is an explanatory diagram that illustrates one example of a format of the responses to the various types of requests that a receiving apparatus according to the embodiment of the disclosure transmits;

FIG. 5 is a flowchart that illustrates one example of a reproduction quality setting process in a transmission apparatus according to the embodiment of the disclosure;

FIG. 6 is an explanatory diagram that illustrates one example of a format of data that a transmission apparatus according to the embodiment of the disclosure transmits;

FIG. 7 is an explanatory diagram that illustrates one example of a synchronization process that is performed between a transmission apparatus and a receiving apparatus according to the embodiment of the disclosure;

FIG. 8 is a flowchart that illustrates one example of a reproduction quality adjustment process in a transmission apparatus according to the embodiment of the disclosure;

FIG. 9 is a flowchart that illustrates another example of a reproduction quality adjustment process in a transmission apparatus according to the embodiment of the disclosure;

FIG. 10 is a flowchart that illustrates still another example of a reproduction quality adjustment process in a transmission apparatus according to the embodiment of the disclosure;

FIG. 11 is a block diagram that illustrates one example of the configuration of a transmission apparatus according to the embodiment of the disclosure;

FIG. 12 is an explanatory diagram that illustrates one example of the hardware configuration of a transmission apparatus according to the embodiment of the disclosure; and

FIG. 13 is a block diagram that illustrates one example of the configuration of a receiving apparatus according to the embodiment of the disclosure.

### DETAILED DESCRIPTION OF EMBODIMENTS

Preferable embodiments of the disclosure will be described in detail below with reference to the drawings. Here, duplicate descriptions are omitted by conferring the same symbols to configuration elements with essentially the same function configurations in the specification and the drawings.

Further, below, description will be made in the following order.

1. Approach According to Embodiment of Disclosure

2. Communication System According to Embodiment of Disclosure

3. Program According to Embodiment of Disclosure

### (Approach According to Embodiment of Disclosure)

Before describing the configuration of each apparatus that configures a communication system according to the embodiment of the disclosure (hereinafter, also referred to as “communication system 1000”), a data transmission approach according to the embodiment of the disclosure will be described.

### [Outline of Communication System 1000]

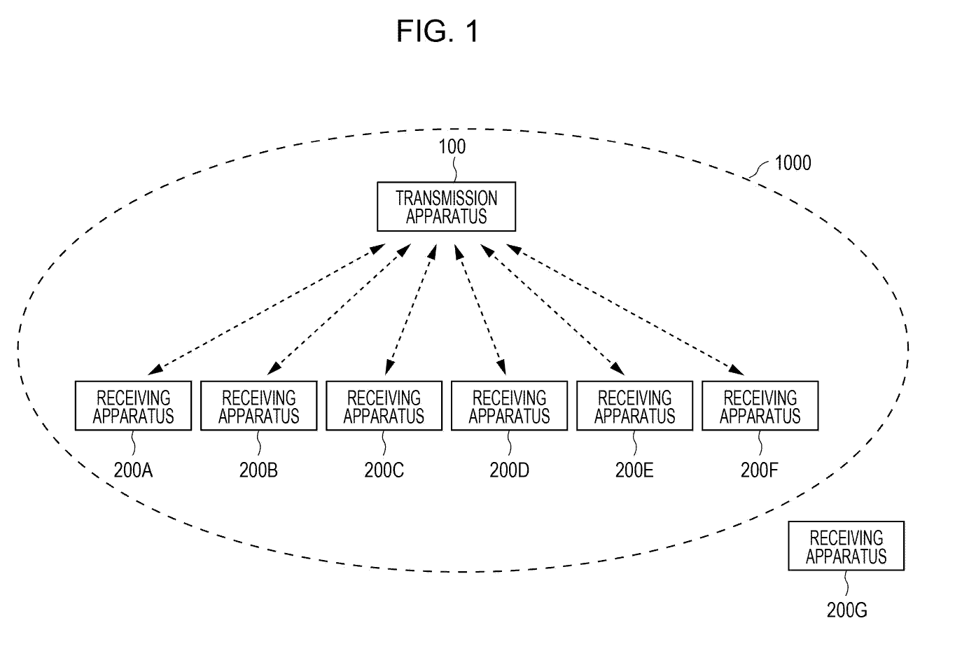

Before describing the outline of a data transmission approach according to the embodiment of the disclosure, the outline of the communication stem 1000 according to the embodiment of the disclosure will be described. FIG. 1 is an explanatory diagram that illustrates the outline of the communication system 1000 according to the embodiment of the disclosure. The communication system 1000 includes a transmission apparatus 100 and receiving apparatuses 200A, 200B, . . . (hereinafter, also collectively referred to as “receiving apparatuses 200”).

The transmission apparatus 100 and the receiving apparatuses 200 perform communication by, for example, wired communication such as by LAN (Local Area Network) or by wireless communication such as by IEEE802.11g or IEEE802.15. Here, in FIG. 1, a case in which the transmission apparatus 100 and the receiving apparatuses 200 perform communication by wireless communication is illustrated. Here, although not illustrated in FIG. 1, in a case when IEEE802.11g is used as the wireless communication, for example, the transmission apparatus 100 and the receiving apparatuses 200 perform communication via a relay apparatus that acts as an access point.

Further, with the communication system 1000, various types of requests and commands such as a communication request (described later), information (data) that is transmitted according to the various types of requests, transmission, and the like, for example, are transceived by “UDP unicast packets”, for example. Here, the communication system 1000 according to the embodiment of the disclosure is also able to perform transceiving of various requests or the like by an arbitrary format conforming to a DLNA (Digital Living Network Alliance) standard. Further, the various types of requests in the communication system 1000 according to the embodiment of the disclosure are not limited to the above, and various types such as a start of transmission notification of transmission data, a transmission stop request of transmission data, and a retransmission request of transmission data, for example, are exemplified.

The communication system 1000 according to the embodiment of the disclosure is formed by the transmission apparatus 100 transmitting communication requests to each of the receiving apparatuses that are the transmission destinations of transmission data, and each of the receiving apparatuses 200 performing responses to perform communication to the communication requests. That is, the communication system 1000 is formed by the transmission apparatus 100 requesting the participation of each of the receiving apparatuses 200 to the system, and each of the receiving apparatus 200 responding to the request. In FIG. 1, an example in which six receiving apparatuses 200 of a receiving apparatus 200A to a receiving apparatus 200F configure the communication system 1000, and in which a receiving apparatus 200G does not configure the communication system 1000 is illustrated.

The outline of the transmission apparatus 100 and the receiving apparatuses 200 will be described below with the communication system 1000 illustrated in FIG. 1 as an example. Here, for example, in a case when the receiving apparatus 200A illustrated in FIG. 1 transmits the above communication request to the transmission apparatus 100 or another receiving apparatus 200, it is possible for the receiving apparatus 200A illustrated in FIG. 1 to act as the transmission apparatus and for the transmission apparatus 100 illustrated in FIG. 1 to act as a receiving apparatus.

In the communication system 1000, the transmission apparatus 100 has the function of transmitting transmission data to each of the receiving apparatuses 200 (that is, the receiving apparatuses 200 that are the transmission destinations of the transmission data. Hereinbelow, also referred to as “transmission destination apparatuses”) that configure the communication system 1000. More specifically, the transmission apparatus 100 respectively sets the transmission data to be transmitted to the transmission destination apparatuses for each of the transmission destination apparatuses. Furthermore, the transmission apparatus 100 transmits the transmission data to be transmitted to each of the transmission destination apparatuses all at once.

Here, the transmission data according to the embodiment of the disclosure is data of content such as audio and images such as, for example, audio data, moving image data, and still image data. Further, below, a case in which the transmitted data that is respectively transmitted to the receiving apparatuses 200 that are the transmission destinations from the transmission apparatus 100 is audio data will be mainly described.

The receiving apparatuses 200 receive the transmission data that is transmitted from the transmission apparatus 100 and perform reproduction of the received transmission data. Here, as the reproduction by the receiving apparatuses 200, stream reproduction, for example, is exemplified. By each of the receiving apparatuses 200 stream reproducing the transmission data that is transmitted from the transmission apparatus 100 all at once, with the communication system 1000, it is possible for the plurality of receiving apparatuses 200 that are provided in different rooms, for example, to reproduce the same content all at once. Here, the reproduction method of the data that is received by the plurality of receiving apparatuses 200 is not limited to stream reproduction. For example, the receiving apparatuses 200 according to the embodiment of the disclosure are able to store the received transmission data in a storage apparatus (described later) and reproduce the stored transmission data.

In addition, the receiving apparatuses 200 are not limited to receiving and reproducing the transmission data that is transmitted from the transmission apparatus 100. For example, the receiving apparatuses 200 may have a configuration of being able to reproduce content data that is obtained from various recording media such as an optical disc such as a DVD disc, a magnetic recording medium such as a hard disk, or a USB (Universal Serial Bus) memory or content data that is obtained via a tuner, an external input terminal, or the like.

By including the transmission apparatus 100 and the receiving apparatuses 200 as described, for example, the communication system 1000 transmits transmission data to the plurality of receiving apparatuses 200 all at once and causes content according to the transmission data to be reproduced by the receiving apparatuses 200. The data transmission approach according to the embodiment of the disclosure will be described below with the communication system 1000 illustrated in FIG. 1 as an example.

### [Outline of Data Transmission Approach]

As described above, even if the technique of the related art or the method of (a) to (d) described above are used, it is difficult to realize prevention of a decrease in convenience to the user while securing the reproduction quality of the reproduction of transmission data by receiving apparatuses in a communication system in which transmission data is transmitted to a plurality of receiving apparatuses all at once.

For example, in the case of a wireless communication in which the communication between the transmission apparatus and each of the receiving apparatuses that are the transmission destinations uses IEEE 802.11g, although the theoretical value of the transfer rate is 54 [Mbps], since the throughput decreases by the strength of the radio waves, the effective value of the transfer rate (that is, the standard transfer rate) is approximately 20 to 30 [Mbps]. Here, in a case when the transmission data that is transmitted from the transmission apparatus is audio data of LPCM (Linear Pulse-Code Modulation) (for example, in a case when the transfer rate is LPCM of 1.4 [Mbps]), even if the wireless environment is relatively good (for example, when the standard transfer rate is 25 [Mbps]), by Equation 1 below, the transmission data is only able to be transmitted to 8 or so receiving apparatuses. In Equation 1, the calculation includes a multiplication by “2” since it is supposed that the transmission data that is transmitted from the transmission apparatus reaches the receiving apparatuses via an access point. Here, since the wireless environment is not necessarily maintained as the environment described above, the number of receiving apparatuses that are able to stably receive the transmission data in the case described above is appropriately 4 or 5.

25 [Mbps]/(1.4 [Mbps]□2)=8.9 (1)

Here, as illustrated in (b) described above, if the transmission data that is transmitted by the transmission apparatus is DPCM (Differential Pulse Code Modulation) audio data in which LPCM audio data is compressed, for example, since the differential transfer rate becomes large, it is possible to confer spare capacity to the bandwidth. Therefore, in the above case, it is possible to transmit transmission data to still more receiving apparatuses. However, in the above case, since compressed audio data is transmitted to all receiving apparatuses as transmission destinations, the audio quality in the communication system as a whole decreases.

Therefore, in the communication system 1000 according to the embodiment of the disclosure, the transmission apparatus 100 adjusts the reproduction quality of the transmission data based on the retransmission request frequency that indicates the number of times that a retransmission request with respect to the transmission data is received from the receiving apparatuses 200 over a predetermined amount of time. In so doing, in the communication system 1000, if spare capacity in the bandwidth disappears and the frequency by which retransmission requests with regard to the transmission data are received from the receiving apparatuses increases, the transmission apparatus 100 is able to set the reproduction quality of the transmission data with regard to the receiving apparatuses to be low. On the other hand, if there is spare capacity in the bandwidth and the frequency by which retransmission requests with regard to the transmission data are received from the receiving apparatuses decreases, the reproduction quality of the transmission data with regard to the receiving apparatuses is able to be set high.

Therefore, the communication system 1000 in which the disparity between the reproduction quality and the bandwidth of the transmission data is reduced and in which it is possible to adjust the reproduction quality according to the bandwidth is realized.

More specifically, with the communication system 1000, by the transmission apparatus 100 performing the process of (1) and the process of (2) described below, the disparity between the reproduction quality and the bandwidth of the transmission data is reduced and the reproduction quality is adjusted according to the bandwidth. Here, the process of (1) and the process of (2) below are examples of processes according to the transmission apparatus according to the embodiment of the disclosure.

### (1) Reproduction Quality Adjustment Process

As described above, in a case when the communication between the transmission apparatus 100 and each of the receiving apparatuses 200 that are the transmission apparatuses is a wireless communication using IEEE802.11g, in a case when the transmission data that is transmitted from the transmission apparatus 100 is LPCM audio data, the number of receiving apparatuses 200 that are able to stably receive the transmission data is approximately 4 or 5. In such a case, depending on the wireless environment (distance, obstacles, and the like), there may be case in which more receiving apparatuses 200 are able to be connected to the transmission apparatus 100, while there may be a case when the number of receiving apparatuses 200 that are connected to the transmission apparatus 100 is reduced in order to maintain communication without cutting off, or a case when the reproduction quality of the transmission data is changed.

By adjusting the reproduction quality of the transmission data that is transmitted from the transmission apparatus 100 to the receiving apparatuses 200 based on the retransmission requests that are transmitted from the receiving apparatuses 200, the limited bandwidth is used effectively while the possibility of the audio or images that are reproduced by the receiving apparatuses 200 being cut off is decreased. In more detail, the transmission apparatus 100 adjusts the reproduction quality of the transmission data based on the retransmission request frequency that indicates the number of times that retransmission requests with respect to the packets that are transmitted to the receiving apparatuses 200 are received from the receiving apparatuses 200 over a predetermined period of time.

For example, in a case when the current transmission data is LPCM audio data, the transmission apparatus 100 determines that a stable transmission of audio data is being maintained without cutting off if the frequency of the retransmission requests from the receiving apparatuses 200 is relatively low. Further, the transmission apparatus 100 is able to keep the reproduction quality of the transmission data to such receiving apparatuses 200 high (is able to keep the transmission data to be LPCM audio data).

On the other hand, for example, in a case when the current transmission data is LPCM audio data, the transmission apparatus 100 determines that a stable transmission of audio data is not being maintained if the frequency of the retransmission requests from the receiving apparatuses 200 is relatively high, and is able to adjust the reproduction quality of the transmission data to be low (is able to change the transmission data to DPCM audio data). For example, in a case when the transmission apparatus 100 receives several retransmission requests (for example, 5) from the receiving apparatuses 200 over a predetermined period of time (for example, 300 msec), the transmission data that is transmitted to the receiving apparatus 200 is switched to DPCM audio data. In such a case, the size of the data storing buffer for storing the transmission data is, for example, the amount for storing LPCM audio data corresponding to 500 msec. Here, the predetermined period of time (for example, 300 msec) is, for example, equivalent to the duration of a first watchdog timer described later, and the several times (for example, 5) is equivalent to a third threshold value described later.

Further, for example, in a case when the current transmission data is DPCM audio data, the transmission apparatus 100 determines that there is not much spare capacity in the bandwidth if the frequency by which retransmission requests are received from a receiving apparatus 200 is relatively high, and is able to keep the reproduction quality of the transmission data to the receiving apparatus 200 to be low (is able to keep the transmission data to be DPCM audio data as is).

On the other hand, for example, in a case when the current transmission data is DPCM audio data, the transmission apparatus 100 determines that there is not much spare capacity in the bandwidth if the frequency by which retransmission requests are received from a receiving apparatus 200 is relatively low, and is able to adjust the reproduction quality of the transmission data to be high (is able to change the transmission data to LPCM audio data). For example, if not even one retransmission request is received from a given receiving apparatus 200 over a predetermined period (for example, 60 sec), the transmission apparatus 100 is able to switch the transmission data with respect to the receiving apparatus 200 to LPCM audio data. Here, the predetermined period of time (for example, 60 sec) is equivalent, for example, to the duration of a second watchdog timer described later.

By such a technique, by performing adjustment of the reproduction quality of the transmission data for each receiving apparatus 200, audio is able to be output with high audio quality while using the current bandwidth effectively. Here, by setting the predetermined period that is used to switch from LPCM audio data to DPCM audio data to be shorter than the predetermined period that is used to switch from DPCM audio data to LPCM audio data, it is possible to emphasize avoiding the occurrence of cut offs of the audio in the receiving apparatuses 200.

### [Example of Transmission Data Adjusted by Reproduction Quality Adjustment Process]

Here, one example (one example of content data that is a candidate for the transmission data) of transmission data in which the transmission apparatus 100 adjusts the reproduction quality of the process of (1) (reproduction quality adjustment process) will be described. As the transmission data in which the transmission apparatus 100 adjusts the reproduction quality in the process of (1) (reproduction quality adjustment process), (A) to (C) below, for example, are exemplified.

(A) Case when Transmission Data is Audio Data

In a case when the transmission data is audio data of sounds, the transmission apparatus 100 treats uncompressed audio data such as LPCM audio data or audio data that is compressed by a predetermined compression method such as DPCM as transmission data in which the reproduction quality is to be adjusted. Here, since the reproduction quality of uncompressed audio data is generally higher than that of compressed audio data, the transmission apparatus 100 treats, for example, the uncompressed audio data as the transmission data with the higher reproduction quality. Here, the transmission apparatus 100 is not limited to treating uncompressed audio data and audio data that is compressed by one compression method as candidates for the transmission data, and for example, uncompressed audio data and audio data that is compressed by a plurality of compression methods, may be candidates for the transmission data.

(B) Case when Transmission Data is Image Data of Moving Image

In a case when the transmission data is image data of a moving image, the transmission apparatus 100 treats, for example, a piece of image data out of a plurality of pieces of image data in which one or both of a plurality of resolutions and compression formats are different as the transmission data of which the reproduction quality is to be adjusted. Here, the transmission data with the higher reproduction quality in the above case is treated, for example, based on the resolution of the content data that is to be the source of the transmission data, the compression format, or the like. For example, the transmission apparatus 100 treats the transmission data in which the resolution of the content data that is to be the source does not decrease as the transmission data with the higher reproduction quality, and treats the transmission data in which the resolution of the content data that is to be the source decreases as the transmission data with the lower reproduction quality.

(C) Case when Transmission Data is Image Data of Still Image Data

In a case when the transmission data is image data of a still image, the transmission apparatus 100 treats, for example, a piece of image data out of a plurality of pieces of image data with different data sizes, as the transmission data. For example, with the content data itself that is to be the source as the transmission data with the higher reproduction quality, the transmission apparatus 100 treats image data in which the image size of the content data that is to be the source is irreversibly compressed as the transmission data with the lower reproduction quality.

The transmission apparatus 100 sets the transmission data as shown in (A) to (C) above, for example in the process of (1) (reproduction quality adjustment process). Here, needless to say, the transmission data that is set by the transmission apparatus 100 according to the embodiment of the disclosure is not limited to the transmission data shown in (A) to (B) above.

### (2) Transmission Process

The transmission apparatus 100 transmits the transmission data that is set for each of the receiving apparatuses 200 as the transmission destination in the process of (1) (reproduction quality adjustment process) described above to the corresponding receiving apparatuses 200. In the communication system 1000, by the transmission apparatus 100 performing, for example, the process of (1) (reproduction quality adjustment process described above and the process of (2) (transmission process), the transmission data is transmitted to the receiving apparatuses 200. Here, with the transmission apparatus 100, in the process of (1) (reproduction quality adjustment process) described above, the reproduction quality of the transmission data is adjusted for each of the receiving apparatuses 200.

Therefore, by the transmission apparatus 100 performing, for example, the process of (1) (reproduction quality adjustment process described above and the process of (2) (transmission process), the communication system 1000 in which the disparity between the reproduction quality and the bandwidth of the transmission data is reduced and in which it is possible to adjust the reproduction quality according to the bandwidth is realized.

### [Specific Example of Process Relating to Data Transmission Approach]

Next, the process relating to the data transmission approach according to the embodiment of the disclosure of the communication system 1000 will be described specifically. Below, description will be made with an example of a case when the transmission apparatus 100 transmits audio data as the transmission data to the receiving apparatuses 200 as the transmission destinations.

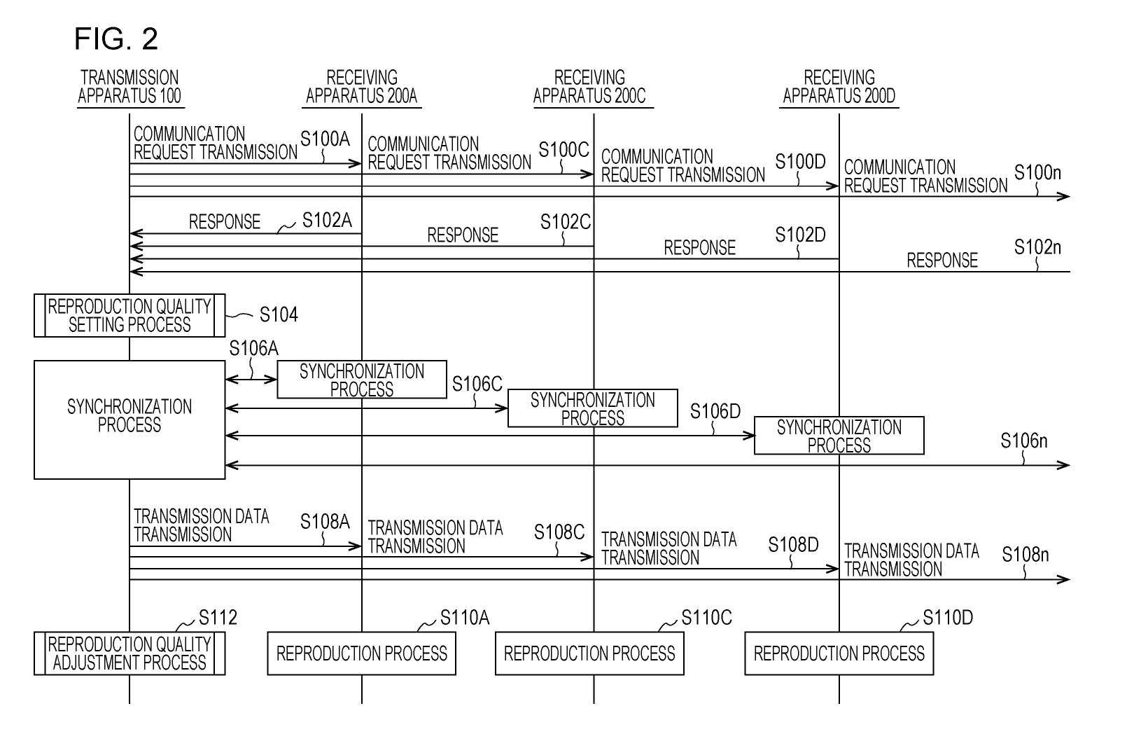

FIG. 2 is an explanatory diagram that illustrates one example of the process of the data transmission approach in the communication system 1000 according to the embodiment of the disclosure. Here, FIG. 2 representatively illustrates the receiving apparatus 200A, the receiving apparatus 200C, and the receiving apparatus 200D out of the receiving apparatuses 200 illustrated in FIG. 1.

The transmission apparatus 100 transmits communication requests (S100A, S100C, S100D, S100n. Hereinafter, collectively referred to as “S100”) to each of the receiving apparatuses 200 based on a user operation that is performed on, for example, an operation unit (described later). Here, a communication request that the transmission apparatus 100 transmits in step S100 is a type of command, for example, for causing each of the receiving apparatuses 200 to transmit a response in order to specify the receiving apparatus 200 that is the transmission destination of the transmission data. Further, a communication request according to the embodiment of the disclosure is also able to be perceived as an invitation to join the communication system 1000 which is transmitted from the transmission apparatus 100 to each of the receiving apparatuses 200. That is, the communication system 1000 as illustrated in FIG. 1 is formed by the transmission apparatus 100 performing the process of step S100 and each of the receiving apparatuses 200 performing step S102 described later.

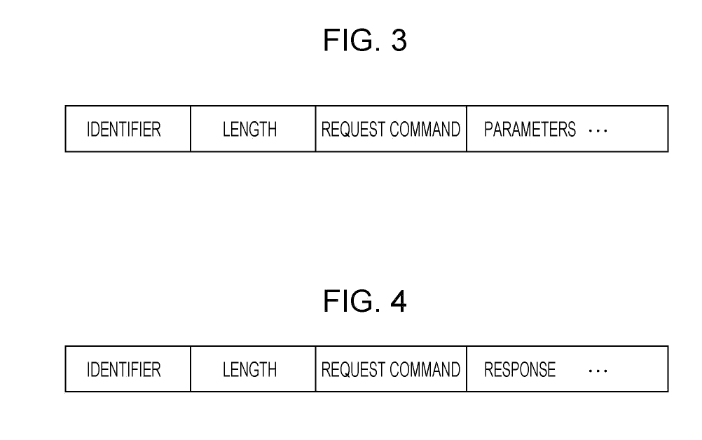

FIG. 3 is an explanatory diagram that illustrates one example of various types of formats of requests that the transmission apparatus 100 according to the embodiment of the disclosure transmits. As illustrated in FIG. 3, the transmission apparatus 100 transmits requests including, for example, an identifier, information of the length, a request command, and parameters. Here, the identifier is information for identifying the protocol, and the information of the length indicates the data length of the request command, for example. Further, the request command indicates the content of the order, and the parameters indicate the parameter relating to the request command.

The transmission apparatus 100 generates various types of requests such as the communication request of step S100 in accordance with the format indicated in FIG. 3, for example, and transmits the various types of generated requests to the receiving apparatuses 200. Here, needless to say, the formats of the various types of requests that the transmission apparatus 100 according to the embodiment of the disclosure transmits are not limited to FIG. 3.

One example of the process relating to the data transmission approach in the communication system 1000 will be described with reference to FIG. 2 once again. The receiving apparatuses 200 that receive the communication requests that are transmitted from the transmission apparatus in step S100 transmit the responses to the communication requests to the transmission apparatus 100 (S102A, S102C, S102D, S102n. Hereinafter, collectively referred to as “S102”). Below, description is made wherein the receiving apparatuses 200A to 200F illustrated in FIG. 1 perform responses (response to join the communication system 1000) that indicate that receiving of transmission data is possible, and the receiving apparatus 200G performs a response (response not to join the communication system 1000) that indicates that receiving of transmission data is difficult.

FIG. 4 is an explanatory diagram that illustrates one example of the formats of the responses to the various types of requests that the receiving apparatuses 200 according to the embodiment of the disclosure transmit. As illustrated in FIG. 4, the receiving apparatuses 200 transmit requests that include, for example, an identifier, information of the length, a request command, and information of the response. Here, the identifier is information for identifying the protocol, and the information of the length indicates the data length of the request command, for example. Further, the request command indicates what order the response is to, and the information of the response indicates the content of the response relating to the request command. As the information of the response that the receiving apparatus 200 generates, data according to the various types of requests such as ACK (ACKnowledgement) is exemplified.

The receiving apparatuses 200 perform responses to the various types of requests such as the communication request of step S100 in accordance with the format illustrated in FIG. 4, for example. Here, needless to say, the formats of the various types of requests that the transmission apparatus 100 according to the embodiment of the disclosure transmits are not limited to FIG. 3.

One example of the process relating to the data transmission approach in the communication system 1000 will be described with reference to FIG. 2 once again. When responses from each of the receiving apparatuses 200 are received in step S102, the transmission apparatus 100 sets the receiving apparatuses 200 that performed responses to indicate that receiving of the transmission data is possible as the receiving apparatuses 200 that are the transmission destinations of the transmission data. The transmission apparatus 100 is able to specify the number of transmission destination apparatuses by setting the receiving apparatuses 200 that are the transmission destinations based on the response in step S102.

The transmission apparatus 100 that has received the apparatus information that is transmitted from each of the receiving apparatuses 200 in step S102 sets the reproduction quality of the transmission data that is transmitted to the receiving apparatuses 200 that are the transmission destinations (S104; reproduction quality setting process).

### [Example of Reproduction Quality Setting Process]

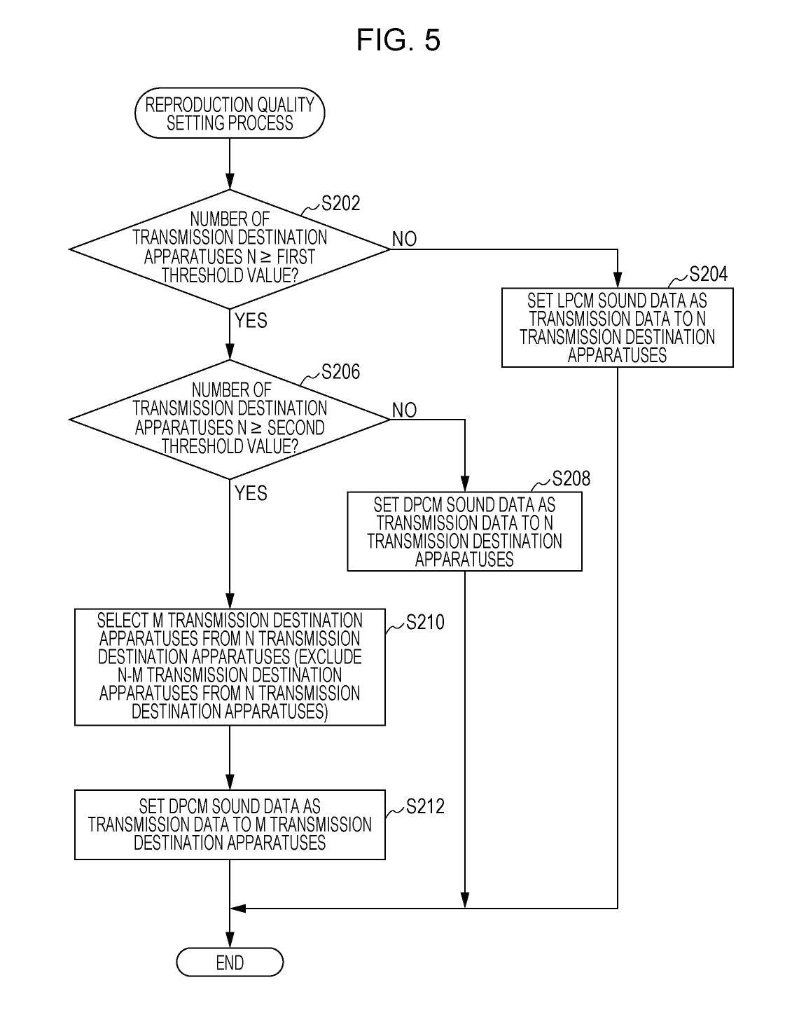

FIG. 5 is a flowchart that illustrates one example of the reproduction quality setting process in the transmission apparatus 100 according to the embodiment of the disclosure. One example of the reproduction quality setting process will be described below with a case when the transmission apparatus 100 and each of the receiving apparatuses 200 perform wireless communication in accordance with IEEE802.11g.

Further, one example of the reproduction quality setting process will be described below with a case when the transmission apparatus 100 sets either LPCM audio data in which the transfer rate is 1.4 [Mbps] (one example of transmission data with a higher reproduction quality) or DPCM audio data in which the transfer rate is 0.7 [Mpbs] (one example of transmission data with a lower reproduction quality than LPCM) as the transmission data as an example.

The transmission apparatus 100 sets the number corresponding to the number of receiving apparatuses 200 from which responses to the communication requests were received in step S102 of FIG. 2 as the number of transmission destination apparatuses N (N is an integer) and determines whether the number of transmission destination apparatuses N is equal to or greater than a first threshold value (s202). Here, the first threshold value is equivalent to a first predetermined number described later. The transmission apparatus 100 sets, in a case when it is determined that the number of transmission destination apparatuses N is less than the first threshold value, LPCM audio data as the transmission data for the N transmission destination apparatuses (S204).

The transmission apparatus 100 determines, in a case when it is determined that the number of transmission destination apparatuses N is equal to or greater than the first threshold value, whether or not the number of transmission destination apparatuses N is equal to or greater than a second threshold value (S206). Here, the second threshold value is equivalent to a second predetermined value described later. The transmission apparatus 100 sets, in a case when it is determined that the number of transmission destination apparatuses N is less than the second threshold value, DPCM audio data as the transmission data for the N transmission destination apparatuses (S208).

The transmission apparatus 100 selects, in a case when it is determined that the number of transmission destination apparatuses N is equal to or greater than the second threshold value, M transmission destination apparatuses (M is a positive integer) from among the N transmission destination apparatuses (excludes N-M transmission destination apparatuses from N transmission destination apparatuses) (S210), and sets DPCM audio data as the transmission data to the M transmission destination apparatuses (S212). M is a value that is smaller than the second threshold value, and, for example, is a value that is smaller than the second threshold value by 1.

One example of the process relating to the data transmission approach in the communication system 1000 will be described with reference to FIG. 2 once again. Once the reproduction quality of the transmission data that is transmitted to each of the receiving apparatuses 200 that are transmission destinations are set in step S108, the transmission apparatus 100 performs a synchronization process for transmitting the transmission data all at once between each of the receiving apparatuses 200 (S106A, S106C, S106D, S106n. Hereinafter, collectively referred to as “S106”). Here, as the synchronization process according to the embodiment of the disclosure, for example, the transmission apparatus 100 transmitting a start of transmission notification that includes information of the start of transmission time, information of the reproduction start time, or the like of the transmission data and the receiving apparatuses 200 performing processes relating to the preparation for the reproduction of the transmission data according to the start of transmission notification and responses to the start of transmission notification according to the start of transmission notification is exemplified.

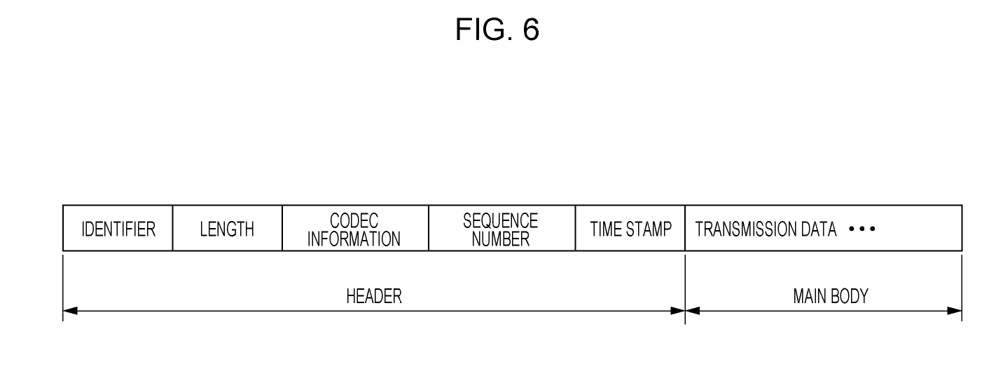

FIG. 6 is an explanatory diagram that illustrates one example of the format of the data that the transmission apparatus 100 according to the embodiment of the disclosure transmits. As illustrated in FIG. 6, the transmission apparatus 100 transmits an identifier, information of the length, codec information, a sequence number, a time stamp, and transmission data in step S108. Here, the identifier is information for identifying the protocol, and the information of the length indicates the data length of the codec information, for example. Further, the codec information indicates the codec of the transmission data, the sequence number is the order of the transmission data, and the time stamp is information that indicates the reproduction time. The transmission data is actual data such as audio data or image data that is reproduced by the receiving apparatuses 200. The transmission data includes 320 samples in the case of LPCM audio data and 640 samples in the case of DPCM audio data. 1 sample of the LPCM audio data includes 16 bit □2 (L, Rch).

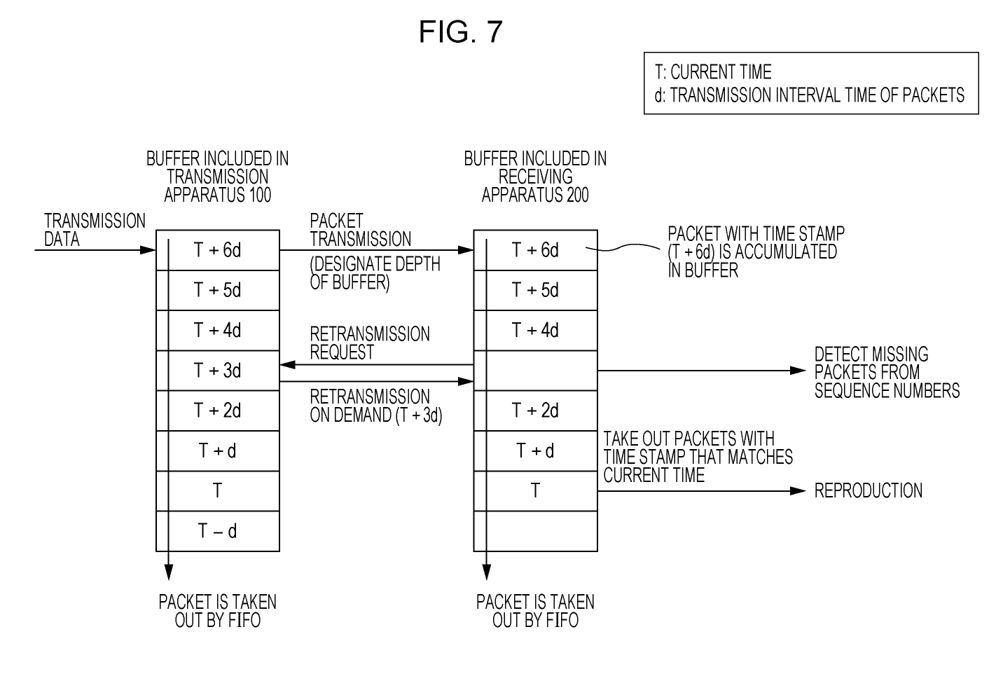

FIG. 7 is an explanatory diagram that illustrates one example of the synchronization process that is performed between the transmission apparatus 100 according to the embodiment of the disclosure and the receiving apparatus 200. As described above, the transmission apparatus 100 transmits, for example, transmission data and various types of requests to the receiving apparatus 200 by “UDP unicast packets”. Although it is possible to realize a fast transfer speed with UDP that is a protocol of a transport layer, UDP has a characteristic in which it is difficult to realize high reliability. Generally, functions for detecting packet loss, data error, or the like during communication are realized by functions that are provided by an application.

As described above, in a case when using wireless as the infrastructure, the electric field strength changes by the distance between the transmission apparatus and the receiving apparatus and an access point, the presence of obstacles, the structure of a home, or the like, and the transfer rate of the transmission data from the transmission apparatus to the receiving apparatus is greatly influenced by such a change in the electric field strength. If the transfer rate changes, there may be spare capacity in the bandwidth or spare capacity may disappear from the bandwidth during communication.

Further, in particular, as the transmission data amount becomes smaller, the possibility that an undesirable state of affairs such as the occurrence of the audio or the images to be reproduced by the receiving apparatuses 200 cutting off increases. On the other hand, in a case when the transmission data that is received by the receiving apparatuses 200 is stream reproduced, it is important that the transmission data is continuously received by the receiving apparatuses 200. While it is important that the transmission data has continuity in such a manner, in a case when UDP is used as the transmission method between the transmission apparatus 100 and the receiving apparatuses 200 or the like, there is a high likelihood that packets that are transmitted from the transmission apparatus 100 to the receiving apparatuses 200 will go missing.

For such a reason, the communication system 1000 secures a buffer for data storage for both the transmission apparatus 100 and the receiving apparatuses 200. The transmission apparatus 100 adds sequence numbers in units of transmission data (hereinafter, also referred to as “packets”) within the buffer for data storage and transmits the packets. The receiving apparatuses 200 store the received packets in the buffer for data storage, and in a case when a missing packet is detected, specifies the missing packet by the sequence number and transmits a retransmission request for the packet to the transmission apparatus 100. By such functions, the communication 1000 is able to compensate for packet loss.

One example of the process relating to the data transmission approach in the communication system 1000 will be described with reference to FIG. 2 once again. Once the synchronization process in step S106 is complete, the transmission apparatus 100 transmits the corresponding transmission data in which the reproduction quality is set in step S104 to the receiving apparatuses 200 that are the transmission destinations all at once (S108A, S108C, S108D, S108n. Hereinafter, collectively referred to as “S108”). Further, although the steps S108A, S108C, S108D, and S108n are illustrated separately for convenience in FIG. 2, the transmission apparatus 100 performs synchronization of the process of step S108. That is, the transmission apparatus 100 performs the process of step S108 at the same time (substantially at the same time).

In step S108, the transmission apparatus 100 generates data in accordance with the format illustrated in FIG. 6, for example, and transmits the data to the corresponding receiving apparatuses 200. Further, in step S108, the transmission apparatus 100 generates the transmission data based on the content data that is stored in a storage unit (described later), for example. Here, the transmission apparatus 100 may also generate the transmission data in advance. Further, needless to say, the format of the data that the transmission apparatus 100 according to the embodiment of the disclosure transmits in step S108 is not limited to that in FIG. 6.

One example of the process relating to the data transmission approach in the communication system 1000 will be described with reference to FIG. 2 once again. The receiving apparatuses 200 that have received the transmission data from the transmission apparatus 100 all at once in step S108 reproduces the received transmission data (S110A, S110C, S110D, S110n. Hereinafter, collectively referred to as “S110”). Here, the receiving apparatuses 200 perform a reproduction process based on the process result of the synchronization process of step S106. By the above, the transmission data is reproduced by each of the transmission apparatuses 200 all at once (substantially at once) in the communication system 1000.

### [Example of Reproduction Quality Adjustment Process]

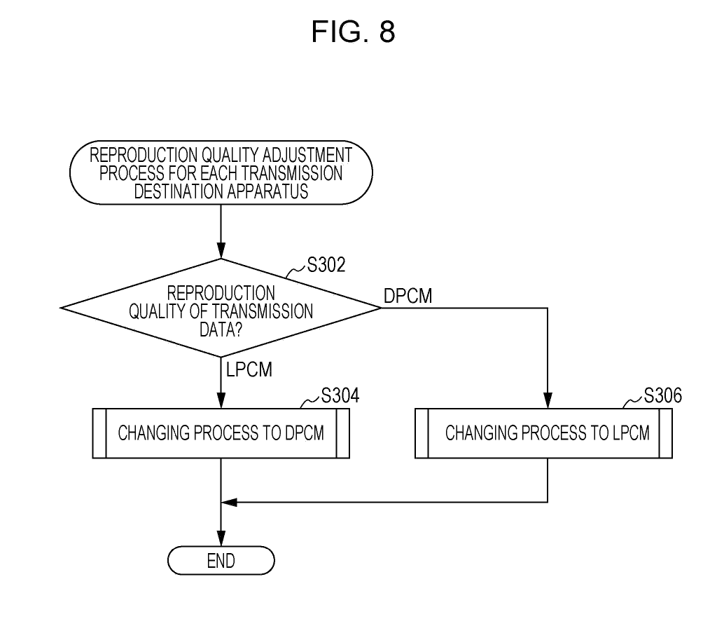

FIGS. 8 to 10 are flowcharts that illustrate one example of the reproduction quality adjustment process in the transmission apparatus 100 according to the embodiment of the disclosure. One example of the reproduction quality adjustment process will be described below with a case in which the transmission apparatus 100 and each of the receiving apparatuses 200 perform wireless communication in accordance with IEEE802.11g as an example.

Further, one example of the reproduction quality adjustment process will be described below with a case when the transmission apparatus 100 sets either LPCM audio data in which the transfer rate is 1.4 [Mbps] (one example of transmission data with a higher reproduction quality) or DPCM audio data in which the transfer rate is 0.7 [Mpbs] (one example of transmission data with a lower reproduction quality than LPCM) as the transmission data as an example. Here, the processes illustrated in FIGS. 8 to 10 may be performed by the transmission apparatus 100 for each receiving apparatus 200.

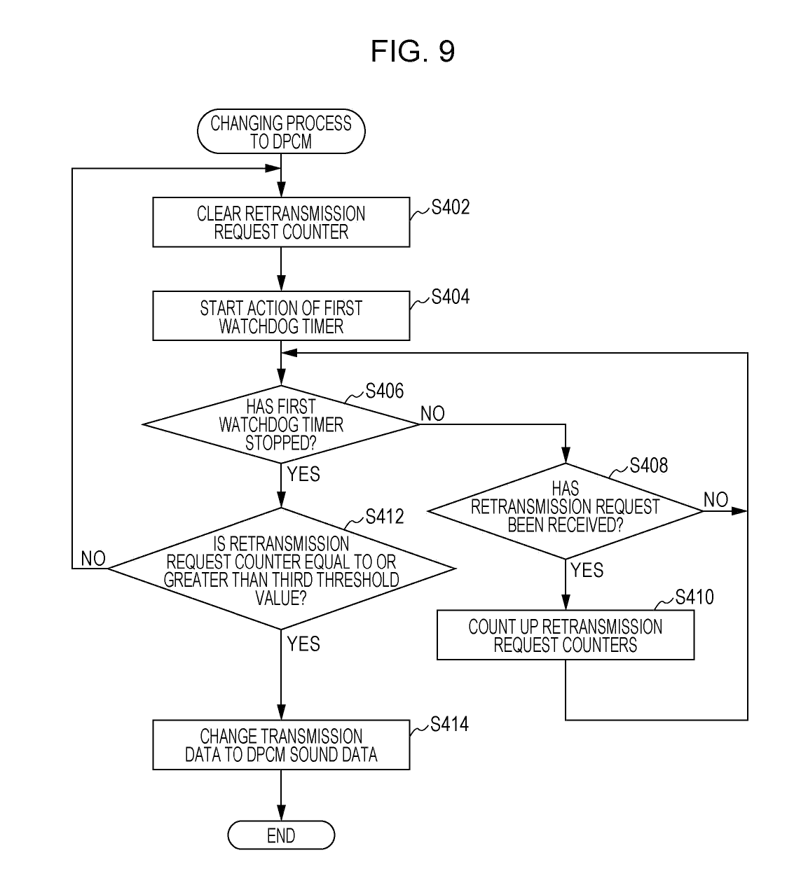

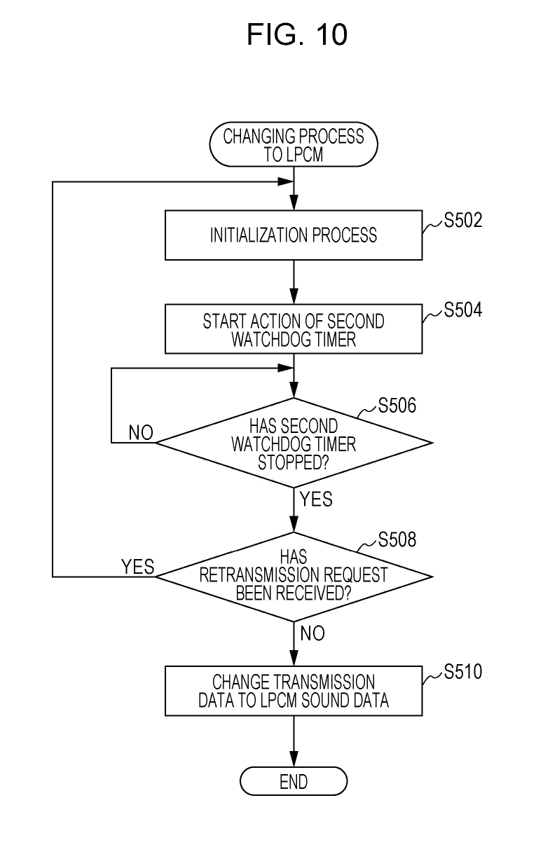

As illustrated in FIG. 8, in a case when the current transmission data is LPCM audio data (“LPCM” in S302), the transmission apparatus 100 performs a changing process to DPCM (S304). The changing process to DPCM (S304) will be described later with reference to FIG. 9. Further, in a case when the current transmission data is DPCM audio data (“DPCM” in S302), the transmission apparatus 100 performs a changing process to LPCM (S306). The changing process to LPCM (S306) will be described later with reference to FIG. 10.

As illustrated in FIG. 9, in the changing process to DPCM (S304), the transmission apparatus 100 first clears the retransmission request counter for counting the number of retransmission requests that are received from the receiving apparatuses 200 (S402). The transmission apparatus 100 starts the action of the first watchdog timer (S404). The first watchdog timer includes a function of stopping once a predetermined amount of time passes from the start of action. In a case when the first watchdog timer is not stopped (“No” in S406), the transmission apparatus 100 counts up, in a case when retransmission requests are received (“Yes” in S408), the retransmission request counter to a predetermined number (for example, “1”) (S410) and returns to S406. In a case when retransmission requests are not received (“No” in S408), S406 is returned to.

In a case when the first watchdog timer is stopped (“Yes” in S406), the transmission apparatus 100 returns to S402 in a case when the retransmission request counter is less than the third threshold value (“No” in S412), and changes the transmission data to DPCM audio data in a case when the retransmission request counter is equal to or greater than the third threshold value (“Yes” in S412). The frequency at which retransmission requests are received by the number of times indicated by the third threshold value during a predetermined amount of time while the action of the first watchdog timer is continuing is equivalent to a first predetermined frequency described later.

As illustrated in FIG. 10, in the changing process to LPCM (S306), the transmission apparatus 100 performs an initialization process (S502). In such an initialization process, for example, the transmission apparatus 100 performs, in a case when a retransmission request is received from a receiving apparatus 200, a process of clearing a storage region for storing information indicating that the request has been received. With the information, the transmission apparatus 100 is able to determine whether or not a retransmission request has been received. Next, the transmission apparatus 100 starts the action of the second watchdog timer (S504). The second watchdog timer includes a function of stopping once a predetermined amount of time passes from the start of action. In a case when the second watchdog timer is not stopped (“No” in S506), the transmission apparatus 100 returns to S506.

In a case when the second watchdog timer is stopped (“Yes” in S506), the transmission apparatus 100 changes, in a case when a retransmission request is received (“Yes” in S508), the transmission data to LPCM audio data. The frequency at which one retransmission request is received during a predetermined amount of time while the action of the second watchdog timer is continuing is equivalent to a second predetermined frequency described later.

In the communication system 1000, the process illustrated in FIG. 2, for example, is performed. The transmission apparatus 100 performs the process of (1) described above (reproduction quality adjustment process) and the process of (2) described above (transmission process). Therefore, for example, by the process illustrated in FIG. 2 being performed, in the communication system 1000, the process of the data transmission approach according to the embodiment of the disclosure described above is realized.

Therefore, by performing the process illustrated in FIG. 2, for example, the communication system 1000 in which the disparity between the reproduction quality and the bandwidth of transmission data is reduced and in which it is possible to adjust the reproduction quality according to the bandwidth is realized. Here, the process relating to the data transmission approach according to the embodiment of the disclosure in the communication system 1000 is not limited to the process illustrated in FIG. 2. For example, the transmission apparatus 100 may periodically transmit transmission data to each of the receiving apparatuses 200, and each of the receiving apparatuses 200 may reproduce the received transmission data.

### (Communication System According to Embodiment of Disclosure)

Next, one example of the configurations of the transmission apparatus 100 and the receiving apparatuses 200 that configure the communication system 1000 in which the process of the data transmission approach according to the embodiment of the disclosure described above is possible will be described.

### [Transmission Apparatus 100]

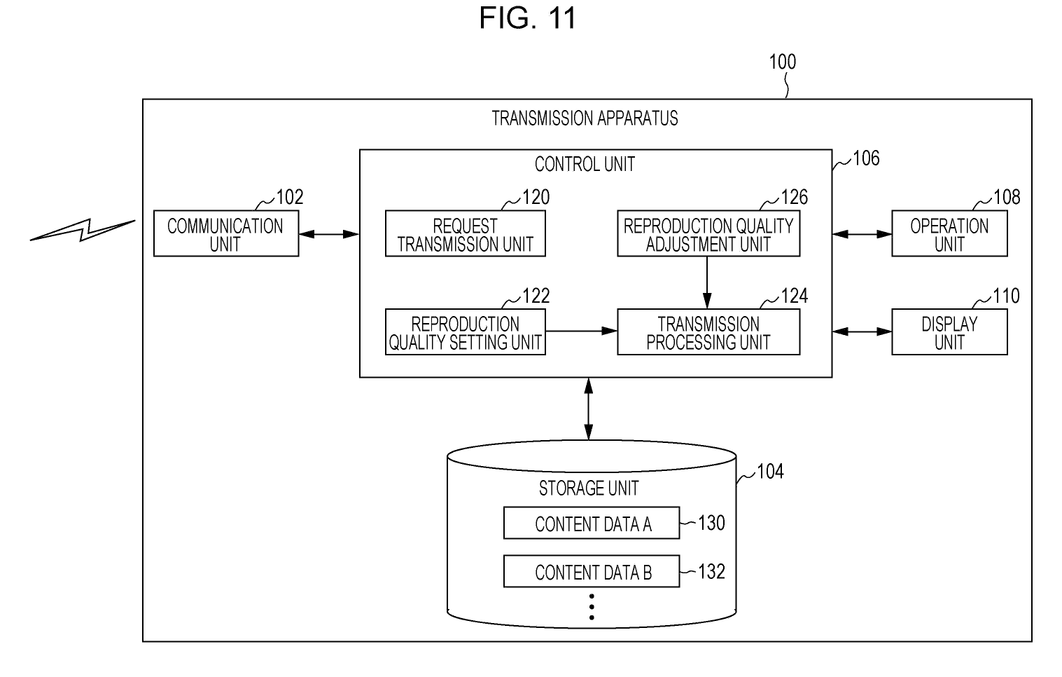

FIG. 11 is a block diagram that illustrates one example of the configuration of the transmission apparatus 100 according to the embodiment of the disclosure. The transmission apparatus 100 includes a communication unit 102, a storage unit 104, a control unit 106, an operation unit 108, and a display unit 110.

Further, the transmission apparatus 100 may include, for example, a ROM (Read Only Memory; not shown), a RAM (Random Access Memory; not shown), or the like. The transmission apparatus 100 connects each of the configuration elements by a bus, for example, as a data transmission path.

Here, the ROM (not shown) stores control data such as programs and operation parameters that the control unit 106 uses. The RAM (not shown) temporarily stores programs and the like that are executed by the control unit 106.

### [Hardware Configuration Example of Transmission Apparatus 100]

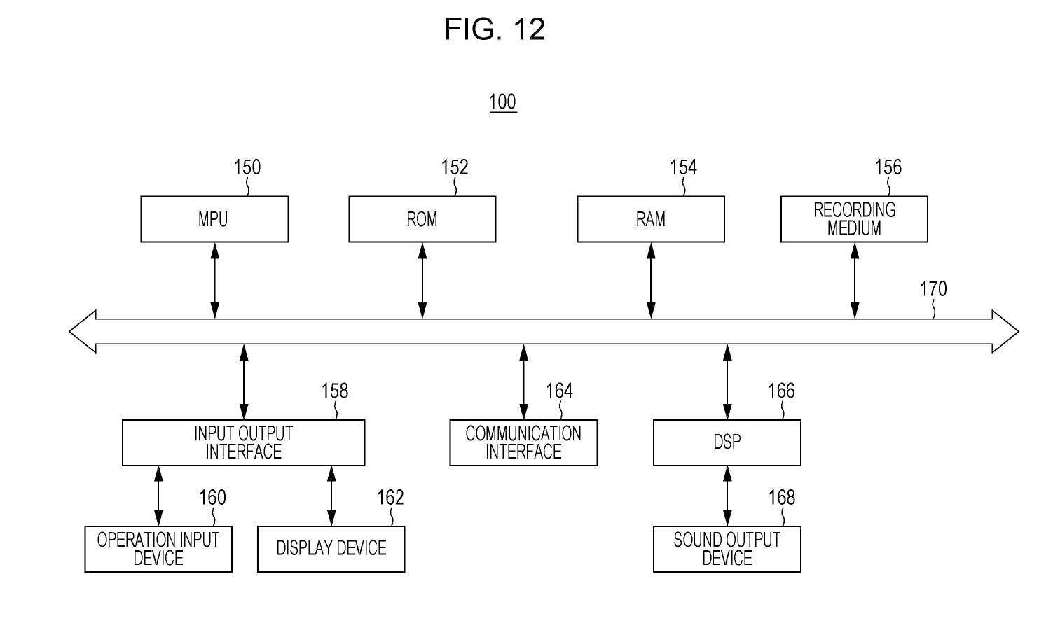

FIG. 12 is an explanatory diagram that illustrates one example of the hardware configuration of the transmission apparatus 100 according to the embodiment of the disclosure. If FIG. 12 is referenced, the transmission apparatus 100 includes, for example, an MPU 150, a ROM 152, a RAM 154, a recording medium 156, an input output interface 158, an operation input device 160, a display device 162, a communication interface 164, a DSP 166, and an audio output device 168. Further, the transmission apparatus 100 connects each of the configuration elements by a bus 170, for example, as a data transmission path.

The MPU 150 is configured by an MPU (Micro Processing Unit) or an integrated circuit in which a plurality of circuits for realizing a control function are integrated, and functions as the control unit 106 that controls the entirety of the transmission apparatus 100. Further, the MPU 150 acts as a request transmission unit 120, a reproduction quality setting unit 122, a transmission processing unit 124, and a reproduction quality adjustment unit 126 in the transmission apparatus 100.

The ROM 152 stores control data such as programs and operation parameters that the MPU 150 uses, data of various types of threshold values according to the embodiment of the disclosure, and the like, and further, the RAM 154 temporarily stores a program that is executed by the MPU 150 or the like, for example.

The recording medium 156 functions as the storage unit 104, and stores a variety of data such as, for example, content data and an application that are the bases of the transmission data. Here, although magnetic recording media such as a hard disk or nonvolatile memories such as an EEPROM (Electrically Erasable and Programmable Read Only Memory), a flash memory, an MRAM (Magnetoresistive Random Access Memory), an FeRAM (Ferroelectric Random Access Memory), and a PRAM (Phase change Random Access Memory) are exemplified as the recording medium 156, the recording medium 156 is not limited to the above. Further, the transmission apparatus 100 is also able to include a recording medium 156 that is detachable from the transmission apparatus 100.

The input output interface 158 connects, for example, the operation input device 160 or the display device 162. The operation input device 160 functions as the operation unit 108, and further, the display device 162 functions as the display unit 110. Here, as the input output interface 158, for example, a USB terminal, a DVI (Digital Visual Interface) terminal, an HDMI (High-Definition Multimedia Interface) terminal, various types of processing circuits, and the like are exemplified. Further, the operation input device 160 is provided on the transmission apparatus 100, for example, and is connected with the input output interface 158 inside the transmission apparatus 100. As the operation input device 160, for example, rotation type selectors such as buttons, arrow keys, and jog dials, or a combination thereof are exemplified.

Further, the display device 162 is provided on the transmission apparatus 100, for example, and is connected to the input output interface 158 inside the transmission apparatus 100. As the display device 162, for example, a liquid crystal display (LCD), an organic EL display (organic ElectroLuminescence display. Also referred to as an OLED display (Organic Light Emitting Diode display)), or the like is exemplified. Here, needless to say, the input output interface 158 is connected to an operation input device (for example, a keyboard, a mouse, or the like) or a display device (for example, an external display or the like) as external apparatuses of the transmission apparatus 100. Further, the display device 162 may be a device that is capable of both display and user operation such as, for example, a touch screen.

The communication interface 164 is a communication section that is included in the transmission apparatus 100, and functions as the communication unit 102 for performing wireless or wired communication with an external apparatus such as the receiving apparatuses 200 or a server (not shown) via a network (or directly). Here, as the communication interface 164, for example, an IEEE802.11g port and a transceiving circuit (wireless communication), an IEEE802.15.1 port and a transceiving circuit (wireless communication), a communication antenna and an RF circuit (wireless communication), or a LAN terminal and a transceiving circuit (wired communication) are exemplified. Here, the transmission apparatus 100 may include a plurality of communication interfaces such as, for example, a communication interface for performing communication with the receiving apparatuses 200 or a communication interface for performing communication with an external apparatus such as a server (not shown).

Here, as the network according to the embodiment of the disclosure, for example, a wired network such as a LAN (Local Area Network) or a WAN (Wide Area Network), a wireless network such as a wireless WAN (WWAN; Wireless Wide Area Network) via a base station or a wireless MAN (WMAN; Wireless Metropolitan Area Network), or the Internet using a communication network such as TCP/IP (Transmission Control Protocol/Internet Protocol) is exemplified.

The DSP 166 acts as a reproduction processing unit (not shown) that reproduces content data that is stored on the recording medium 156 or content data that the communication interface 164 receives. The DSP 166 is configured by a DSP (Digital Signal Processor) or various types of processing circuits, and processes audio data. Further, the audio output device 168 acts as an audio output unit (not shown) that outputs sounds corresponding to audio data, and outputs sounds corresponding to the audio data that is processed by the DSP 166. Here, as the audio output device, for example, an amplifier or a speaker is exemplified.

The transmission apparatus 100 performs the process of the data transmission approach according to the embodiment of the disclosure, for example, by the configuration illustrated in FIG. 12. Here, the hardware configuration of the transmission apparatus 100 according to the embodiment of the disclosure is not limited to the configuration illustrated in FIG. 12. For example, the transmission apparatus 100 may act as a reproduction processing unit (not shown) and may include an image processing circuit that processes image data. Further, in a case when the transmission apparatus 100 has a configuration of not including a reproduction processing unit (not shown) or an audio output unit (not shown), the transmission apparatus 100 may have a configuration of not including the DSP 166, the audio output device 168, or an image processing circuit.

The configuration elements of the transmission apparatus 100 will be described with reference to FIG. 11 once again. The communication 102 is a communication section that is included in the transmission apparatus 100, and performs wireless or wired communication with an external apparatus such as the receiving apparatuses 200 or a server (not shown) via a network (or directly). Further, the communication of the communication unit 102 is controlled by the control unit 106. Here, as the communication unit 102, for example, an IEEE802.11g port and a transceiving circuit (wireless communication), a LAN terminal and a transceiving circuit (wired communication), or the like is exemplified.

The storage unit 104 is a storage section that the transmission apparatus 100 includes. Here, as the storage unit 104, for example, a magnetic recording medium such as a hard disk, a non-volatile memory such as a flash memory, or the like is exemplified.

Further, the storage unit 104 is able to store a variety of data such as, for example, content data and applications. Here, in FIG. 11, an example in which content data A130, content data B132, . . . are stored in the storage unit 104 is illustrated.

The control unit 106 is configured, for example, by an MPU or an integrated circuit in which various types of processing circuits are integrated, and acts to control the entirety of the transmission apparatus 100. Further, the control unit 106 includes the request transmission unit 120, the reproduction quality setting unit 122, the transmission processing unit 124, and the reproduction quality adjustment unit 126, and acts to assume a leading role in performing the process of the data transmission approach according to the embodiment of the disclosure.

The request transmission unit 120 generates various requests such as, for example, the communication request illustrated in FIG. 2, and causes the various types of generated requests to be transmitted by the communication unit 102.

The reproduction quality setting unit 122 acts to assume a leading role in performing the process described above (reproduction quality setting process). More specifically, in a case when there is a plurality of receiving apparatuses 200, the reproduction quality setting unit 122 respectively sets the reproduction quality at the start of transmission of the transmission data for the receiving apparatuses 200 based on the number of the plurality of receiving apparatuses 200.

The transmission processing unit 124 acts to assume a leading role in performing the process of (2) described above (transmission process). More specifically, the transmission processing unit 124 causes the transmission data in which the reproduction quality is set by the reproduction quality setting unit 122 to be transmitted to the receiving apparatuses 200 that are the corresponding transmission destinations via the communication unit 102. Further, the transmission processing unit 124 causes the transmission data in which the reproduction quality is adjusted by the reproduction quality adjustment unit 126 to be transmitted to the receiving apparatuses 200 that are the corresponding transmission destinations via the communication unit 102.

The reproduction quality adjustment unit 126 acts to assume a leading role in performing the process of (1) described above (reproduction quality adjustment process). More specifically, the reproduction quality adjustment unit 126 adjusts the reproduction quality of the transmission data based, for example, on the retransmission request frequency that indicates the number of times that retransmission requests with respect to the transmission data were received from the receiving apparatuses 200 via the communication unit 102 over a predetermined period of time. Although the reproduction quality of the transmission data may be in a variety of forms, in a case when the transmission data is configured by audio data, the reproduction quality of the transmission data is indicated, for example, by codec information such as LPCM or DPCM.

A variety of forms are supposed for the adjustment of the reproduction quality of the transmission data by the reproduction quality adjustment unit 126. For example, the reproduction quality adjustment unit 126 is able to adjust the reproduction quality of the transmission data based on the relationship between the retransmission request frequency and a predetermined frequency. For example, the transmission processing unit 124 is able to transmit transmission data of a predetermined reproduction quality (hereinafter, also referred to as a “first reproduction quality”) or a reproduction quality that is lower than the first reproduction quality (hereinafter, also referred to as a “second reproduction quality”) to the receiving apparatuses 200.

In such a case, the reproduction quality adjustment unit 126 may change the reproduction quality of the transmission data to the second reproduction quality in a case when, for example, the reproduction quality of the transmission data that is currently being transmitted is the first reproduction quality and in a case when the retransmission request frequency is equal to or greater than the first predetermined frequency. Further, the reproduction quality adjustment unit 126 may change the reproduction quality of the transmission data to the first reproduction quality in a case when the reproduction quality of the transmission data that is currently being transmitted is the second reproduction quality and in a case when the retransmission request frequency is less than the second predetermined frequency.

Further, there may be a case when the reproduction quality of the transmission data is not changed. For example, the reproduction quality adjustment unit 126 may not change the reproduction quality of the transmission data in a case when the reproduction quality of the transmission data that is currently being transmitted is the first reproduction quality and in a case when the retransmission request frequency is less than the first predetermined frequency. Further, the reproduction quality adjustment unit 126 may not change the reproduction quality of the transmission data in a case when the reproduction quality of the transmission data that is currently being transmitted is the second reproduction quality and in a case when the retransmission request frequency is equal to or greater than the second predetermined frequency.

It does not matter how the reproduction quality of the transmission data is set by the reproduction quality setting unit 122 at the start of transmission. For example, in a case where there is a plurality of receiving apparatuses 200, the reproduction quality setting unit 122 is able to respectively set the reproduction quality of the transmission data at the start of transmission for the receiving apparatuses 200 based on the number of the plurality of receiving apparatuses 200. In such a case, the transmission process unit 124 may respectively transmit, at the start of transmission of the transmission data, the respective transmission data in which the reproduction quality is set for each receiving apparatus 200 by the reproduction quality adjustment unit 122 to the corresponding receiving apparatuses 200.

In addition, the reproduction quality setting unit 122 may set the reproduction quality by the relationship between the number of receiving apparatuses 200 and a predetermined number. That is, the reproduction quality setting unit 122 is able to respectively set the reproduction quality of the transmission data at the start of transmission for the receiving apparatuses 200 based on the relationship between the number of the plurality of receiving apparatuses 200 and a predetermined number. In more detail, for example, in a case when the number of the plurality of receiving apparatuses 200 is less than a first predetermined number, the reproduction quality setting unit 122 is able to respectively set the reproduction quality of the transmission data at the start of transmission for the plurality of receiving apparatuses 200 to a first reproduction quality. Further, in a case when the number of the plurality of receiving apparatuses 200 is equal to or greater than a first predetermined number, the reproduction quality setting unit 122 is able to respectively set the reproduction quality of the transmission data at the start of transmission for the plurality of receiving apparatuses 200 to a second reproduction quality.

The reproduction quality setting unit 122 may, for example, be able to select the transmission destination apparatuses from the plurality of receiving apparatuses 200 up to a second predetermined number. In more detail, for example, the reproduction quality setting unit 122 is able to respectively set the reproduction quality of the transmission data at the start of transmission for the plurality of receiving apparatuses 200 to the second reproduction quality in a case when the number of the plurality of receiving apparatuses 200 is equal to or greater than the first predetermined number and in a case when the number of the plurality of receiving apparatuses 200 is greater than the first predetermined number and less than the second predetermined number. Further, for example, in a case when the number of the plurality of receiving apparatuses 200 is equal to or greater than the second predetermined number, the reproduction quality setting unit 122 selects a number of receiving apparatuses 200 that is one fewer than the second predetermined number from among the plurality of receiving apparatuses 200 and is able to respectively set the reproduction quality of the transmission data at the start of transmission for the number of receiving apparatuses 200 that is one fewer than the second predetermined number to the second reproduction quality.

The reproduction quality setting unit 122 may, for example, not set the receiving apparatuses that exceed the second predetermined number as transmission destination apparatuses. In more detail, the reproduction quality setting unit 122 is able to omit the setting of the reproduction quality of the transmission data at the start of transmission for each of the one or a plurality of receiving apparatuses 200 that were not selected. In such a case, the transmission processing unit 124 is able to not transmit the transmission data to any of the one or plurality of receiving apparatuses 200 that were not selected by the reproduction quality setting unit 122 out of the plurality of receiving apparatuses 200.

Here, although the value of the first predetermined frequency and the second predetermined frequency is not particularly limited, for example, the first predetermined frequency may be set to a value that is higher than the second predetermined frequency. By setting the first predetermined frequency and the second predetermined frequency in such a manner, it is possible to emphasize avoiding the occurrence of the audio or images being cut off in the receiving apparatuses 200.

The specific nature of the transmission data of the first reproduction quality and the transmission data of the second reproduction quality is not particularly limited. For example, in a case when the transmission data is audio data of sounds, the transmission data of the first reproduction quality may be uncompressed audio data and the transmission data of the second reproduction quality may be audio data that is compressed in a predetermined compression format. The uncompressed audio data is, for example, LPCM audio data, and the audio data that is compressed in a predetermined compression format is, for example, DPCM audio data.

The control unit 106 acts to assume a leading role in performing the process of the data transmission approach according to the embodiment of the disclosure by including, for example, the request transmission unit 120, the reproduction quality setting unit 122, the transmission processing unit 124, and the reproduction quality adjustment unit 126. Here, the configuration of the control unit 106 that the transmission apparatus 100 according to the embodiment of the disclosure includes is not limited to the configuration illustrated in FIG. 11. For example, the control unit 106 according to the embodiment of the disclosure may include a reproduction processing unit (not shown) that reproduces content data.

The operation unit 108 is an operation section that is included in the transmission apparatus 100 which makes an operation by a user possible. The transmission apparatus 100 is able, by including the operation unit 108, to make a user operation possible and to perform a process that is desired by the user according to the user operation. Here, as the operation unit 108, for example, rotation type selectors such as buttons, arrow keys, and jog dials, or a combination thereof are exemplified.

The display unit 110 is a display section that the transmission apparatus 100 includes, and displays a variety of information on a display screen. As the screen that is displayed on the display screen of the display unit 110, for example, an operation screen for causing a desired action to be performed by the transmission apparatus 100, a content reproduction screen according to the reproduction of content data, or the like is exemplified. Here, as the display unit 110, for example, an LCD, an organic EL display, or the like is exemplified. Further, the transmission apparatus 100 is also able to configure the display unit 110 by a touch screen, for example. In the case of the above, the display unit 110 functions as an operation display unit that is capable of both user control and display.

The transmission apparatus 100 is able to realize the process of the data transmission approach according to the embodiment of the disclosure by the configuration illustrated in FIG. 11. Therefore, by the configuration illustrated in FIG. 11, for example, the transmission apparatus 100 is able to reduce the disparity between the reproduction quality and the bandwidth of the transmission data and to adjust the reproduction quality according to the bandwidth. Here, needless to say, the configuration of the transmission apparatus 100 according to the embodiment of the disclosure is not limited to the configuration illustrated in FIG. 11.

### [Receiving Apparatus 200]

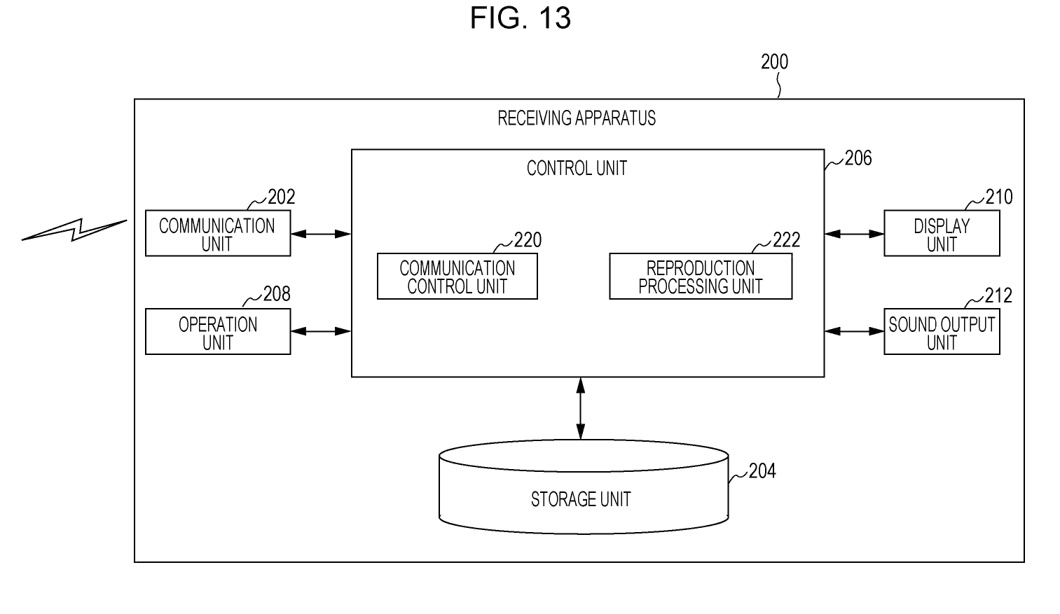

FIG. 13 is a block diagram that illustrates one example of the configuration of a receiving apparatus 200 according to the embodiment of the disclosure. The receiving apparatus 200 includes the communication unit 202, the storage unit 204, the control unit 206, the operation unit 208, the display unit 210, and the audio output unit 212.

Further, the receiving apparatus 200 may include, for example, a ROM (not shown), a RAM (not shown), or the like. The receiving apparatus 200 connects each of the configuration elements by a bus, for example, as a data transmission path.

Here, the ROM (not shown) stores control data such as a program or operation parameters that the control unit used. The RAM (not shown) temporarily stores a program that is executed by the control unit, or the like.

### [Hardware Configuration Example of Receiving Apparatus 200]

The receiving apparatus 200 has the same hardware configuration as the transmission apparatus 100 illustrated in FIG. 12. In a case when the above configuration is adopted, in the receiving apparatus 200, an MPU or a DSP acts as the control unit 206 and a recording medium acts as the storage unit 204. Further, in a case when the above configuration is adopted, in the receiving apparatus 200, the operation input device 160 acts as the operation unit 208 and the display device 162 acts as the display unit 210. Furthermore, in a case when the above configuration is adopted, in the receiving apparatus 200, the communication interface 164 acts as the communication unit 202 and the audio output device 168 acts as the audio output unit 212. Here, needless to say, the configuration of the receiving apparatus 200 according to the embodiment of the disclosure is not limited to the same configuration of the transmission apparatus 100 illustrated in FIG. 12.

The communication unit 202 is a communication section that the receiving apparatus 200 includes, and performs wireless or wired communication with an external apparatus such as the transmission apparatus 100 or a server (not shown) via a network (or directly). Further, the communication of the communication unit 202 is controlled by the control unit 206. Here, as the communication unit 202, for example, an IEEE802.11g port and a transceiving circuit (wireless communication), a LAN terminal and a transceiving circuit (wired communication), or the like is exemplified.

The storage unit 204 is a storage section that the receiving apparatus 200 includes. Here, as the storage unit 204, for example, a magnetic recording medium such as a hard disk, a non-volatile memory such as a flash memory, or the like is exemplified.

Further, the storage unit 204 is able to store a variety of data such as, for example, the transmission data, an application, or the like that is transmitted from the transmission apparatus 100.

The control unit 206 is configured, for example, by an MPU or an integrated circuit in which various types of processing circuits are integrated, and acts to control the entirety of the receiving apparatus 200. Further, the control unit 206 includes the communication control unit 220 and the reproduction processing unit 222, and acts to assume a leading role in performing the process of the receiving apparatus 200 of FIG. 2, for example.

The communication control unit 220 acts to assume a leading role in controlling the communication unit 202 and in performing a process relating to communication with an external apparatus such as the transmission apparatus 100. More specifically, for example, in a case when the communication unit 202 receives the various types of requests that are transmitted from the transmission apparatus 100, the communication control unit 220 performs processes according to the various types of requests that are received, and causes the communication unit 202 to transmit responses according to the various types of requests.

The reproduction processing unit 222 acts to reproduce content data. More specifically, for example, in a case when the data illustrated in FIG. 6 which is transmitted from the transmission apparatus 100 is received from the communication unit 202, the reproduction processing unit 222 reproduces the transmission data based on the codec information. Furthermore, the reproduction processing unit 222 causes images of the image data according to the processing result to be displayed on the display unit 210, and causes sounds of the audio data according to the processing result to be output by the audio output unit 212.

The control unit 206 acts, by including the communication control unit 220 and the reproduction processing unit 222, to assume a leading in performing the process of the receiving apparatus 200 of FIG. 2, for example.

The operation unit 208 is an operation section that is included in the receiving apparatus 200 which makes an operation by a user possible. The receiving apparatus 200 is able, by including the operation unit 208, to make a user operation possible and to perform a process that is desired by the user according to the user operation. Here, as the operation unit 208, for example, rotation type selectors such as buttons, arrow keys, and jog dials, or a combination thereof are exemplified.

The display unit 210 is a display section that the receiving apparatus 200 includes, and displays a variety of information on a display screen. As the screen that is displayed on the display screen of the display unit 210, for example, an operation screen for causing a desired action to be performed by the receiving apparatus 200, a content reproduction screen according to the reproduction of received transmission data or content data, or the like is exemplified. Here, as the display unit 210, an LCD, an organic EL display, or the like is exemplified.

The audio output unit 212 outputs sounds according to the audio data that is processed by the reproduction processing unit 222. As the audio output unit 212, for example, an amplifier or a speaker is exemplified.

The receiving apparatus 200 is able, for example, by the configuration illustrated in FIG. 13, to perform the process of the receiving apparatus 200 of FIG. 2, to receive the transmission data that is transmitted from the transmission apparatus 100, and to reproduce the transmission data.

Here, the configuration of the receiving apparatus 200 according to the embodiment of the disclosure is not limited to the configuration illustrated in FIG. 13. For example, the receiving apparatus 200 according to the embodiment of the disclosure includes the request transmission unit 120, the reproduction quality setting unit 122, the transmission processing unit 124, and the reproduction quality adjustment unit 126 illustrated in FIG. 11, and is also able to perform the data transmission approach according to the embodiment of the disclosure. That is, the receiving apparatus 200 according to the embodiment of the disclosure may include a function as the transmission apparatus 100 according to the embodiment of the disclosure.

As described above, the communication system 1000 according to the embodiment of the disclosure includes the transmission apparatus 100 and the receiving apparatuses 200. The transmission apparatus 100 transmits transmission data to the receiving apparatuses 200 by performing the process of (1) (reproduction quality adjustment process) and the process of (2) (transmission process) described above. Here, in the process of (1) (reproduction quality adjustment process) described above, the transmission apparatus 100 adjusts the reproduction quality of the transmission data based on the retransmission request frequency that indicates the number of times that a retransmission request with respect to the transmission data was received from the receiving apparatuses 200 over a predetermined period. Therefore, in the communication system 1000, in a case when the transmission apparatus 100 receives retransmission requests with respect to the transmission data from the receiving apparatuses 200 at a relatively high frequency, it is determined that there is no spare capacity in the bandwidth and the reproduction quality of the transmission data is able to be lowered. Further, in a case when the transmission apparatus 100 receives retransmission requests with respect to the transmission data from the receiving apparatuses 200 at a relatively low frequency, it is determined that there is spare capacity in the bandwidth and the reproduction quality of the transmission data is able to be increased.

Therefore, by the transmission apparatus 100 performing the process of (1) (reproduction quality adjustment process) and the process of (2) (transmission process) described above, the communication system 1000 in which the disparity between the reproduction quality and the bandwidth of the transmission data is reduced and in which it is possible to adjust the reproduction quality according to the bandwidth is realized.

### [Modification Examples of Communication System 1000]

A configuration in which the communication system 1000 includes the transmission apparatus 100 and the receiving apparatuses 200, and in which the transmission apparatus 100 performs the process of (1) (reproduction quality adjustment process) described above and the process of (2) (transmission process) described above as illustrated in FIG. 1, for example, has been described above. However, the communication system according to the embodiment of the disclosure is not limited to the above configuration. For example, the communication system according to the embodiment of the disclosure may have a configuration of including a control apparatus that performs the process of (1) (reproduction quality adjustment process) described above, a transmission apparatus that performs the process of (2) (transmission process) described above based on the processing result of the control apparatus, and the receiving apparatuses 200. It is also possible to realize a communication system in which it is possible to reduce the disparity between the reproduction quality and the bandwidth of the transmission data and in which the reproduction quality is able to be adjusted according to the bandwidth with the configuration described above.

Although the transmission apparatus 100 has been exemplified and described above as a configuration element that configures the communication system 1000 according to the embodiment of the disclosure, the embodiment of the disclosure is not limited to such an embodiment. The embodiment of the disclosure is able to be applied to a variety of apparatuses such as, for example, a computer such as a PC (Personal Computer), a server, or a PDA (Personal Digital Assistant), a mobile communication apparatus such as a mobile phone or a PHS (Personal Handyphone System), a video and music reproduction apparatus, a video and music recording reproduction apparatus, a mobile game console, or a game console.

Further, although the receiving apparatus 200 has been exemplified as a configuration element that configures the communication system 1000 according to the embodiment of the disclosure, the embodiment of the disclosure is not limited to such an embodiment. The embodiment of the disclosure is able to be applied to a variety of apparatuses such as, for example, a computer such as a PC, a mobile communication apparatus such as a mobile phone, a video and music reproduction apparatus, a video and music recording reproduction apparatus, a mobile game console, or a game console.

### (Program According to Embodiment of Disclosure)

The disparity between the reproduction quality and the bandwidth of transmission data is able to be reduced and the reproduction quality is able to be adjusted according to the bandwidth by a program that causes a computer to function as the transmission apparatus according to the embodiment of the disclosure. Therefore, by using the program that causes a computer to function as the transmission apparatus according to the embodiment of the disclosure, a communication system in which the disparity between the reproduction quality and the bandwidth of the transmission data is reduced and in which it is possible to adjust the reproduction quality according to the bandwidth is realized.

Although a preferable embodiment of the disclosure has been described above with reference to the attached drawings, needless to say, embodiments of the disclosure are not limited to such an example. It should be understood by those skilled in the art that various modifications, combinations, sub-combinations and alterations may occur depending on design requirements and other factors insofar as they are within the scope of the appended claims or the equivalents thereof.

For example, the transmission apparatus according to the embodiment of the disclosure is able to include the request transmission unit 120, the reproduction quality setting unit 122, the transmission processing unit 124, and the reproduction quality adjustment unit 126 illustrated in FIG. 11 separately (for example, by realizing each by separate processing circuits).

Further, although providing a program (computer program) that causes a computer to function as the transmission apparatus according to the embodiment of the disclosure has been shown above, in the embodiment of the disclosure, further, it is possible to provide recording media on which the above program is respectively stored, together.

The configurations described above are one example of the embodiment of the disclosure, and naturally, are within the technical scope of the disclosure.

The present disclosure contains subject matter related to that disclosed in Japanese Priority Patent Application JP 2010-238171 filed in the Japan Patent Office on Oct. 25, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A transmission apparatus comprising:
a communication unit that performs communication with a receiving apparatus;
a transmission processing unit that transmits transmission data to the receiving apparatus via the communication unit; and
a reproduction quality adjustment unit that adjusts a reproduction ion data is received from the receiving apparatus via the communication quality of the transmission data based on a retransmission request frequency that indicates a number of times that a retransmission request with respect to the transmiss unit over a predetermined period of time.

2. The transmission apparatus according to claim 1,
wherein the reproduction quality adjustment unit adjusts a reproduction quality of the transmission data based on a relationship between the retransmission request frequency and a predetermined frequency.

3. The transmission apparatus according to claim 2,
wherein the transmission processing unit transmits the transmission data of a first reproduction quality that is a predetermined reproduction quality or of a second reproduction quality which is lower than the first reproduction quality to the receiving apparatus, and
the reproduction quality adjustment unit changes a reproduction quality of the transmission data to the second reproduction quality in a case when a reproduction quality of the transmission data that is currently being transmitted is a first reproduction quality and in a case when the retransmission request frequency is equal to or greater than a first predetermined frequency, and changes a reproduction quality of the transmission data to the first reproduction quality in a case when a reproduction quality of the transmission data that is currently being transmitted is the second reproduction quality and in a case when the retransmission request frequency is less than a second predetermined frequency.

4. The transmission apparatus according to claim 3,
wherein the reproduction quality adjustment unit does not change a reproduction quality of the transmission data in a case when a reproduction quality of the transmission data that is currently being transmitted is the first reproduction quality and in a case when the retransmission request frequency is less than the first predetermined frequency, and does not change a reproduction quality of the transmission data in a case when a reproduction quality of the transmission data that is currently being transmitted is the second reproduction quality and in a case when the retransmission request frequency is equal to or greater than the second predetermined frequency.

5. The transmission apparatus according to claim 4,
wherein the transmission apparatus further includes a reproduction quality setting unit that sets, in a case when there is a plurality of receiving apparatuses, a reproduction quality of the transmission data at a start of transmission for each of the receiving apparatuses based on a number of the plurality of receiving apparatuses, and
the transmission processing unit respectively transmits, at a start of transmission of the transmission data, the respective transmission data in which the reproduction quality is set for each of the receiving apparatuses by the reproduction quality setting unit to the corresponding receiving apparatuses.

6. The transmission apparatus according to claim 5,
wherein the reproduction quality setting unit sets a reproduction quality of the transmission data at a start of transmission for each of the receiving apparatuses based on a relationship between a number of the plurality of receiving apparatuses and a predetermined number.

7. The transmission apparatus according to claim 6,
wherein the reproduction quality setting unit sets a reproduction quality of the transmission data at a start of transmission to the first reproduction quality for each of the plurality of receiving apparatuses in a case when a number of the plurality of receiving apparatuses is less than a first predetermined number, and sets a reproduction quality of the transmission data at a start of transmission to the second reproduction quality for each of the plurality of receiving apparatuses in a case when a number of the plurality of receiving apparatuses is equal to or greater than the first predetermined number.

8. The transmission apparatus according to claim 7,
wherein the reproduction quality setting unit sets a reproduction quality of the transmission data at a start of transmission to the second reproduction quality for each of the plurality of receiving apparatuses in a case when a number of the plurality of receiving apparatuses is equal to or greater than the first predetermined number and in a case when a number of the plurality of receiving apparatuses is less than a second predetermined number which is greater than the first predetermined number, and in a case when a number of the plurality of receiving apparatuses is equal to or greater than the second predetermined number, selects one fewer receiving apparatus than the second predetermined number of the plurality of receiving apparatuses and sets a reproduction quality of the transmission data at a start of transmission to the second reproduction quality for each of the selected receiving apparatuses that are one fewer than the second predetermined number.

9. The transmission apparatus according to claim 8,
wherein the reproduction quality setting unit omits setting of a reproduction quality of the transmission data at a start of transmission for each of one or a plurality of receiving apparatuses that were not selected, and
the transmission processing unit does not transmit the transmission data to any of one or a plurality of receiving apparatuses that were not selected by the reproduction quality setting unit out of the plurality of receiving apparatuses.

10. The transmission apparatus according to claim 3,
wherein the first predetermined frequency is a higher value than the second predetermined frequency.

11. The transmission apparatus according to claim 1,
wherein in a case when the transmission data is audio data of sounds,
the transmission data of the first reproduction quality is uncompressed audio data and the transmission data of the second reproduction quality is audio data that is compressed in a predetermined compression format.

12. A transmission method comprising:
transmitting transmission data to a receiving apparatus; and
adjusting a reproduction quality of the transmission data based on a retransmission request frequency that indicates a number of times that a retransmission request with respect to the transmission data is received from the receiving apparatus over a predetermined period of time.

13. A communication system comprising:
a transmission apparatus; and
a receiving apparatus which is able to communicate with the transmission apparatus,
wherein the transmission apparatus includes
a communication unit that performs communication with the receiving unit,
a transmission processing unit that transmits transmission data to the receiving apparatus via the communication unit, and
a reproduction quality adjustment that adjusts a reproduction quality of the transmission data based on a retransmission request frequency that indicates a number of times that a retransmission request with respect to the transmission data is received from the receiving apparatus via the communication unit over a predetermined period of time.
